(19) United States
(12) Patent Application Publication
(10) Pub. No.: US 2013/0031597 A1
(43) Pub. Date: Jan. 31, 2013

(54) METHOD AND EQUIPMENT FOR SECURITY ISOLATION OF A CLIENT COMPUTER

(71) Applicant: Jorni Santana DA SILVEIRA, Rio de Janeiro (BR)

(72) Inventor: Jorni Santana DA SILVEIRA, Rio de Janeiro (BR)

(21) Appl. No.: 13/438,115

(22) Filed: Apr. 3, 2012

(30) Foreign Application Priority Data
Jul. 25, 2011 (BR) PI1103480-7

(51) Int. Cl. G06F 21/00

(52) U.S. Cl. 726/1

(57) ABSTRACT

A method and equipment to protect the client computer against attacks through a device that carries out the security isolation of the client computer. It includes isolating all kinds of media that allow for writings in the computer. It uses security software, such as Firewall and antivirus programs configured according to the company's needs and also software to access the company's server, such as a browser or its own software.

### CROSS REFERENCE TO RELATED APPLICATIONS

This application claims priority of Application No. PI 1103480-7 filed in Brazil on 25 Jul. 2011 under 35 U.S.C. §119, the entire contents of which are hereby incorporated by reference.

### BACKGROUND OF THE INVENTION

1. Field of the Invention

The present invention is related to the protection of digital documents in general, but it refers more specifically to a method and equipment designed to create a security cell capable of isolating a client computer from ill-intentioned codes or malware that may be present in a main computer.

2. Description of the Related Art

Today, the security of digital contents is focused on servers and means of communication (networks), while in the client computers such security is limited to firewalls, antivirus programs, IDS, and other similar software and devices. These, however, even when well configured, which is not always the case, remain vulnerable to downloads and damaging configurations “forced upon” or “pushed” by ill-intentioned users into client computers.

Fortunately, there are today more and more Cryptography/Descriptography software and devices that pose a real barrier to attacks. Furthermore, configured servers may be kept isolated and under constant monitoring, which may guarantee an acceptable level of security. In spite of this, the vulnerability of client computers, especially of those operated by beginner or intermediate level users, remains a reality and poses a real threat to the whole system in which they operate, particularly to banks and internet businesses.

Because it is possible to write in client computers, damaging materials or programs may be written in them. Also, security programs may be reconfigured in order to allow for client computers to be accessed by unauthorized users, either physically or virtually. It is a usual practice of hackers to substitute damaging materials for common files belonging to operating systems or applications, by using similar files or adding them in a binary way. The obvious results of such practices are infected client computers.

### BRIEF SUMMARY OF THE INVENTION

The present invention provides specified equipment and a method to protect digital materials, by isolating client computers from possible attacks. Such equipment is provided with an Operating System that must be used through a ROM (Read Only Memory) medium; the latter must have its space fully utilized and should not allow any kind of rewriting. Additionally, this solution requires that some files in the server be checked so that the system installed in the equipment may be recognized and certified. The Operating System must be configured as basically as possible, containing only the essential applications to access the internet and software such as a Firewall, a Crypto/Descriptograhy System, and software to access the company's system, all configured according to the needs of the company. Finally, it must be added that the system should not save or download anything, except through the security cell or the RAM. The HD and other media will have to be disabled.

According to the specifications of the present invention, the security cell will isolate the computer every time it is turned on. This will protect the computer from any attack of damaging materials, even when the latter has been previously installed in the computer, either because of an error in the configuration of some program or because of hackers' actions.

### BRIEF DESCRIPTION OF THE DRAWINGS

The drawings below will help understand the method and equipment proposed in this invention.

FIG. 1 presents a diagram showing the sequence of putting together the security cell, on the client's side.

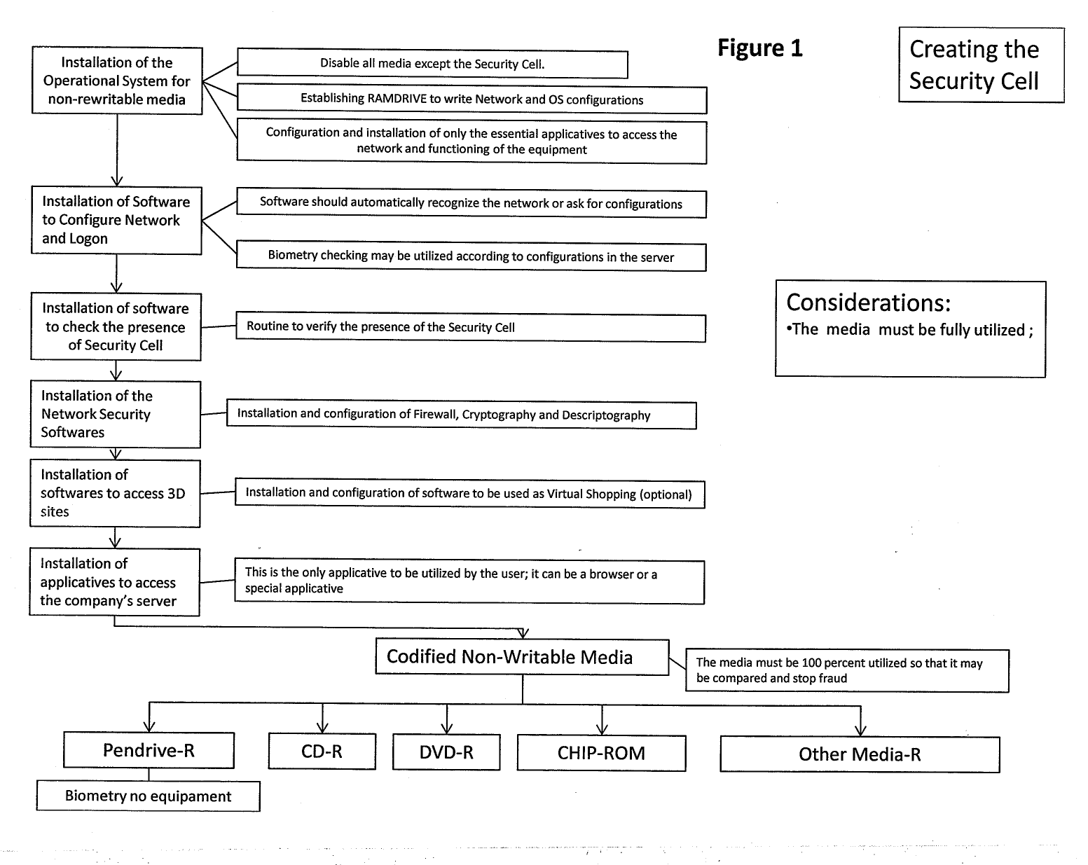

FIG. 2 shows a view of the equipment, already with the biometry option.

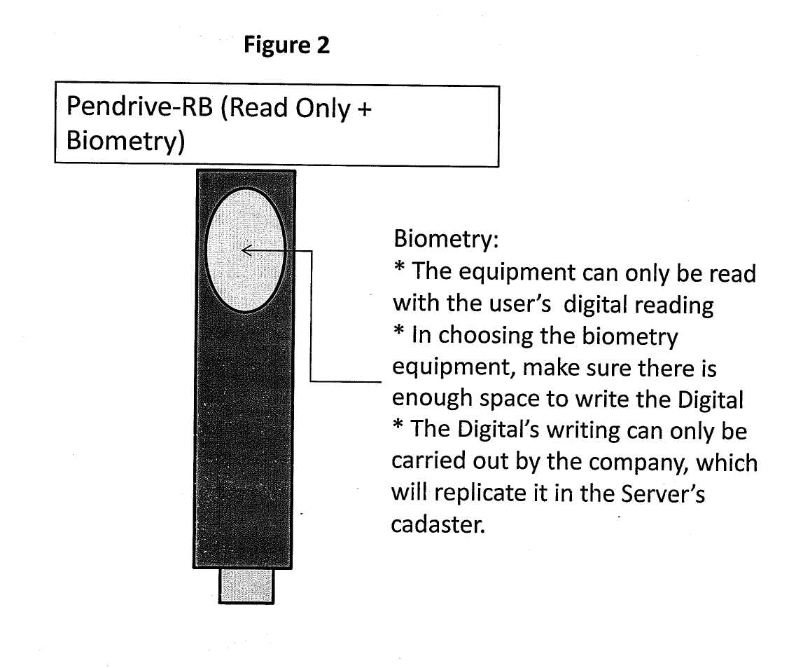

FIG. 3 presents a diagram with the sequence of configurations of the security cell, on the server's side.

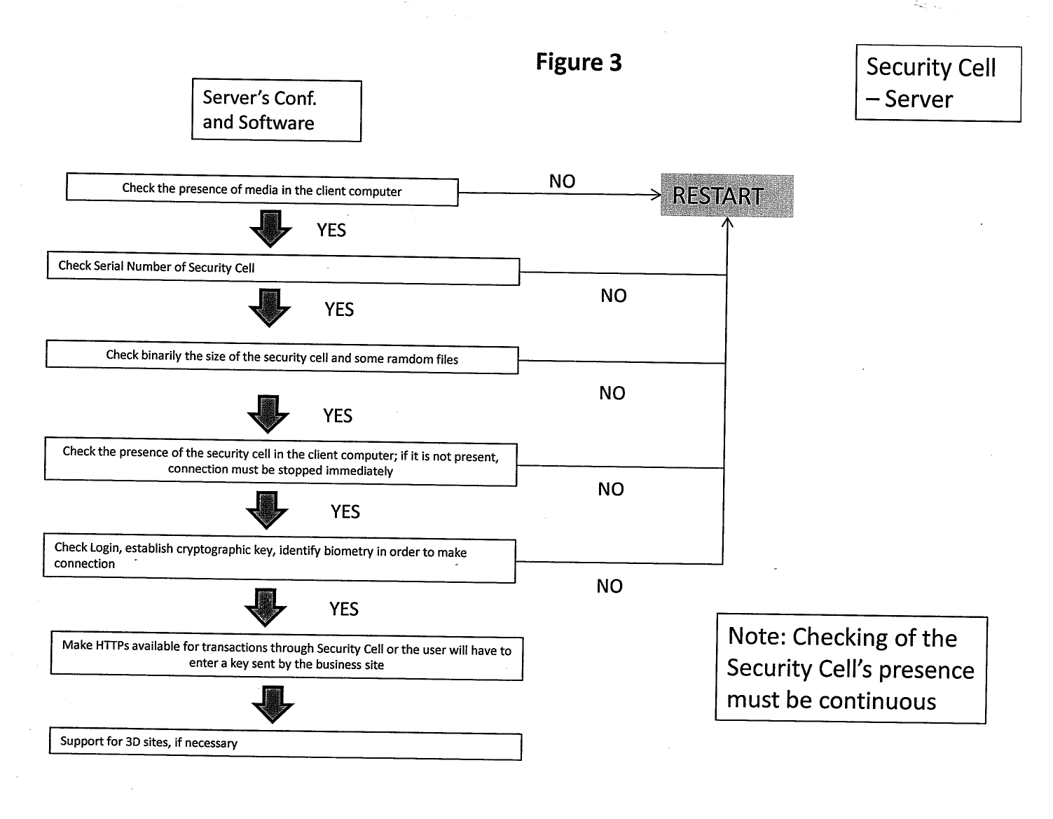

FIG. 4 shows a diagram with the sequence for making use of the security cell, utilized by the client.

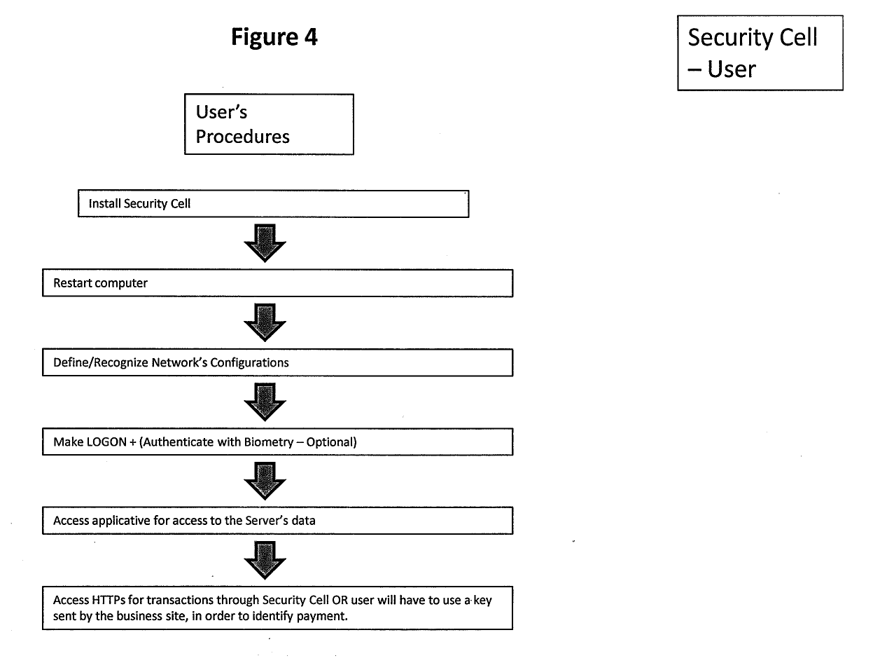

### DETAILED DESCRIPTION OF THE INVENTION

The present invention is provided with a method to securely isolate the client computer (security cell) that includes the binary checking of some key files in the operating system. Furthermore, by using up all the space available in the disk, it blocks any additional writing, while its size is continually compared with what is determined in the server. It also allows for the use of a medium that checks biometry. This equipment can only be accessed through the user's own digital identification.

Today's systems devoted to security on the internet are based on secured servers and channels of communication, with cryptographies and certified servers included. This is fundamental for the security of communications, but they do not always bar the attacks of hackers, which have been causing great losses to institutions, banks and internet commerce.

Most of the effort, however, seems to go to the opposite side of the attacks, which leaves the most vulnerable elements of the system—mainly users' computers—without due protection. Client computers are used at home, to carry out bank transactions, purchases through the internet, and also exchange of confidential information. These personal computers are the main concern of hackers and other ill-intentioned people, who try to capture their confidential data or simply to destroy them.

The present invention proposes a solution to this problem by installing a security cell capable of minimizing monitoring possibilities from the outside, independently of the user's knowledge level, by this way providing an adequate security to communications. Today's protection, devices and software designed for computer users, such as firewall and anti-virus programs, are useful but require technical knowledge to be well operated and also leave open some possibilities for attacks that an experienced hacker can identify and exploit.

The method of the present patent is a Security Cell (an environment with restricted configurations) capable of both turning a client computer into a secure environment and guaranteeing secure communications between the client computer and other computers, without requiring any expert knowledge from the user.

The present methodology was designed to allow bank transactions and internet businesses to take place and expand within a safe environment, where confidential information may be exchanged without the risk of being captured and misused by third parties. As mentioned before, this security system isolates computers from risks in a way that goes beyond the devices and software presently available in the market.

This system prevents its users from committing common mistakes because all of its configurations are restricted and cannot be altered. For this to be hold, the following procedures will have to be followed:
(i) The media must be non-rewritable (CD-R, DVD-R, Pendrive-R, and so on);
(ii) The operating system to be installed must be one that can be operated directly from a non-rewritable medium, with the recognizing configurations of the type HD CD/DVD/USB; these devices must have their writing space fully utilized and cannot be accessed;
(iii) Basic security softwares (Crypt/Descript, Firewall, etc.) must be installed plus a software to access the main server (browser or the company's own software);
(iv) It is necessary that the operating system allows for the creation of a virtual disk in the RAM Memory, where the configuration and data manipulation of the present system will take place;
(v) Finally, it is necessary to have a user-friendly network configuration software for connection with the Internet.

### Pre-Requisites for the Present Method The following pre-requisites are necessary:

To use a writing means that may be read by a computer but where no rewriting is possible; it can be a CD-ROM, DVD-ROM, CHIP-ROM, or a PENDRIVER-ROM, i.e. all must have a Read Only Memory.
The writing space of the means of writing must be totally used up;
To utilize an operating system that may be implemented/executed from a non-writing medium.
To configure a RAMDRIVE (Virtual Disk in RAM memory) with the standard denomination of a HD for temporary network configuration.
To configure the above-mentioned Operating System so that it does not allow access to any type of medium/devide except the one containing the security cell, i. e., no access to the HD, USB, CD, DVD, etc.
To provide the operating system with a routine that requires that the medium for the security cell be read within a certain period of time, so that the security cell cannot be removed during the procedure.
To configure the operating system with only the most basic format, containing only the necessary programs that will make it function properly.
The operating system, once started, must ask the user for (or recognize automatically) the net configurations that make possible the access to the Internet.
After configuring the access to the internet, the operating system must be configured to immediately start the software of access to the company's servers (Browser or the company's software) without allowing exiting from it.
The security softwares commonly present in client computers must be installed in the following manner: (a) Firewall Software, previously configured according to the company's policies; (b) Cryptography/Descriptography Software, previously configured according to the company's policies; (c) Software of Access to the Internet; (d) Software of Access to the Company's Server, with browser or own software; and (e) Software to verify the presence of the security cell during the procedure. Other softwares may be installed if they are necessary to the company (3D and others).
The software for access to the company's server must be configured so as to have sites or portals appropriate for electronic purchasing.
In order to guarantee authenticity, it is necessary that some files of the security cell as well the total disk size be binarily compared while the Log On is taking place.
To indicate the media serial numbers.

Although the present invention has been described in all its representative characteristics, it must be understood by all persons versed in these subject matters that several changes in its form and contents can be made without altering its scope or spirit of the invention, as it is expressed in the claims below.

The preferred modalities must be considered only in their descriptive sense and not as limitations. Therefore, the scope of the invention is defined not only by the detailed description of its representative modalities but also by the claims below, and all the differences found in the scope will be considered as included in the present invention.

1. A method for security isolation of a client computer comprising:
determining which software will be installed and how it will be configured;
determining a form of media writing;
determining a type of media to be used;
determining rules of security; and
determining security configurations both in the server computer and in the client computer.

2. The method for security isolation of a client computer according to claim 1, further comprising:
isolating the client computer; and
allowing a safe communications channel between the client computer and the server, wherein pre-existent files are prevented from being present or modification of data contained in the media is prevented, and software and configurations are linked to the security of data communications.

3. Equipment for security isolation of a client computer comprising:
a unit that starts or restarts the computer and executes the scripts contained a security cell;
said security cell contains network configurations, login and password information, and a program for safe access to servers through the internet.

4. Equipment for security isolation of a client computer, according to claim 3, further comprising: configurations that may be used that to identify only a unique user, or to have a generic medium where the user is identified only in the moment of the logon with the server, where there will be a list of Sites/Systems that will be accessed in the company's server.

5. A system for security isolation of a client computer comprising:
an Operating System that functions from a non-rewritable medium and utilizes a virtual disk in RAM memory (RAMDRIVE) that allows information to be written during its utilization;
a configuration for a crypto/descript software, a firewall program, an antivirus program;
software to access the company's server; and
wherein the system is configured to stop the identification of any medium device, except the one carrying the security cell.
